(19) United States
(12) Patent Application Publication
(10) Pub. No.: US 2010/0315440 A1
(43) Pub. Date: Dec. 16, 2010

(54) ADAPTIVE VIEWING OF REMOTE DOCUMENTS ON MOBILE DEVICES

(75) Inventors: Paul C. Castro, Sharon, MA (US); Yun-Wu Huang, Chappaqua, NY (US)

Correspondence Address: FERENCE & ASSOCIATES LLC, 409 BROAD STREET, PITTSBURGH, PA, 15143, US

(73) Assignee: International Business Machines Corporation, Armonk, NY (US)

(21) Appl. No.: 12/484,351

(22) Filed: Jun. 15, 2009

(51) Int. Cl. G09G 5/00; G06F 17/30; H04M 1/00

(52) U.S. Cl. 345/666; 455/566; 707/770; 707/705; 707/802

(57) ABSTRACT

Embodiments of the invention provide adaptive viewing of a page on mobile electronic devices with a small screen size and/or limited connectivity. Embodiments of the invention enable a user to more easily and quickly download and view a page on a small display screen, such as a display screen of a mobile electronic device. Embodiments of the invention determine an initial portion of a page for download and transmission as well as a sequential order of page portions for subsequent download and transmission to a mobile electronic device.

### BACKGROUND

The field of the invention is viewing of documents on mobile electronic devices. There has been a great increase in the use of mobile electronic devices (e.g. mobile/cellular/smart phones, PDAs, microcomputers, handheld computing and gaming devices and the like). These mobile electronic devices have become increasingly complex. The number and type of applications that these mobile electronic devices support and implement is impressive and will likely continue to increase. The size of these mobile electronics devices is relatively small compared to conventional laptop and desktop computers in order to promote their mobility. Unfortunately, the small size of these mobile electronic devices proves difficult in some contexts, particularly with regard to applications that permit users to download pages (e.g. of remote documents including but not limited to Internet web pages, presentations, etc.) for viewing on a mobile electronic device.

One consequence of the reduced size of mobile electronic devices is a relatively small display screen as compared to traditional desktop and/or laptop computers. The small screen size of these mobile electronic devices leads to difficulties including but not limited to difficulty in appropriate viewing of pages. These mobile electronic devices also often do not have optimal network connections necessary for quickly downloading and viewing pages, especially if the pages are large (in terms of file size).

The state-of-the-art approach for viewing a page on a mobile electronic device involves first downloading the entire page to the device, and then applying scaling function to fit the page on the smaller screen. Typically the user employs a zoom-in function to expand a certain area of the page in order to see more details.

Accordingly, the inventors have recognized a need for improving the downloading and viewing of pages of remote documents with mobile electronic devices.

### BRIEF SUMMARY

At least one presently preferred embodiment of the invention broadly contemplates improved ways of viewing a page (e.g. of a remote document including but not limited to an Internet web page, slide of a presentation, etc.) on mobile electronic devices with a small screen size and/or slow/limited connectivity. An embodiment of the invention preferably chooses a high-fidelity version of the page to ensure legibility (especially upon zooming) but does not download the entire page for the initial display on the small screen of the mobile electronic device. An embodiment of the invention works upon the assumption that if an entire page is shown on the screen, the user will use zoom-in function to achieve legibility. Thus, the actual information displayed on the screen is not the entire page, but a portion of the page (i.e. the zoomed-in portion). The more a zoom-in operation is applied, the smaller the portion of the entire page that is displayed on the screen.

An embodiment of the invention provides methods that intelligently determine which portion of a page is to be initially downloaded and scaled to fit the screen for initial display. Since the initial download involves only a portion of the entire page, the size of information to be downloaded is reduced, resulting in a shortened download time, which can be advantageous if a low bandwidth connection is being utilized. Because the downloaded content is from a high-fidelity page, it is likely to be legible after scaling (e.g. zooming in). A high-fidelity (resolution) page is preferred because high resolution has more detailed information and though best viewed in a large screen, if only a small screen is available (such as on mobile electronic devices), then viewing one part at a time in order to see the details is preferred. The content of the remainder of the page can then be downloaded in the background (e.g. using pre-fetching) while the initially downloaded partial page (portion of the page) is being displayed and reviewed by the user.

In summary, one aspect of the invention provides an apparatus comprising: one or more processors; and a computer readable storage medium having computer readable program code embodied therewith, the computer readable program code, executable by the one or more processors, comprising: computer readable program code configured to enable receiving a page download request from a mobile electronic device; computer readable program code configured to determine an initial portion of a page related to the page download request; and computer readable program code configured to sequentially transmit portions of the page to the mobile electronic device beginning with the initial portion of the page; wherein the initial portion of the page is determined based on one or more of a starting location within the page, a scaling factor and a screen size of the mobile electronic device.

Another aspect of the invention provides a method comprising: receiving a page download request from a mobile electronic device; determining an initial portion of a page related to the page download request; and sequentially transmitting portions of the page to the mobile electronic device beginning with the initial portion of the page; wherein the initial portion of the page is determined based on one or more of a starting location within the page, a scaling factor and a screen size of the mobile electronic device.

A further aspect of the invention provides a computer readable storage medium having computer readable program code embodied therewith, the computer readable program code comprising: computer readable program code configured to enable receiving a page download request from a mobile electronic device; computer readable program code configured to determine an initial portion of a page related to the page download request; and computer readable program code configured to sequentially transmit portions of the page to the mobile electronic device beginning with the initial portion of the page; wherein the initial portion of the page is determined based on one or more of a starting location within the page, a scaling factor and a screen size of the mobile electronic device.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE SEVERAL VIEWS OF THE DRAWINGS

FIG. 1 illustrates components of a mobile electronic device.

FIG. 2 illustrates a mobile electronic device.

FIG. 3 illustrates a method for adaptive download and display of a page.

FIG. 4 illustrates a method for determining critical information indicating an initial portion of a page to be downloaded for display.

FIG. 5 illustrates a method for determining and applying a scan path.

FIG. 6 illustrates an exemplary scan path for a page.

### DETAILED DESCRIPTION

It will be readily understood that the components of the embodiments of the present invention, as generally described and illustrated in the figures herein, may be arranged and designed in a wide variety of different configurations in addition to the described presently preferred embodiments. Thus, the following more detailed description of the embodiments of the present invention, as represented in the figures, is not intended to limit the scope of the invention, as claimed, but is merely representative of selected presently preferred embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, etc. In other instances, well-known structures, materials, or operations are not shown or described in detail to avoid obscuring aspects of the embodiments of the invention.

The illustrated embodiments of the invention will be best understood by reference to the drawings. The following description is intended only by way of example, and simply illustrates certain selected presently preferred embodiments of the invention as claimed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

At least one presently preferred embodiment of the invention provides improved ways of viewing a page (a “page” as used herein includes but is not limited to a page of a remote document such as an Internet web page, slide of a presentation, a page of a word processing document and the like) on mobile electronic devices with a small screen size and/or limited processing power and/or limited/slow connectivity. An embodiment of the invention enables a user to more easily and quickly download and view a page on a small display screen, such as a display screen of a mobile electronic device.

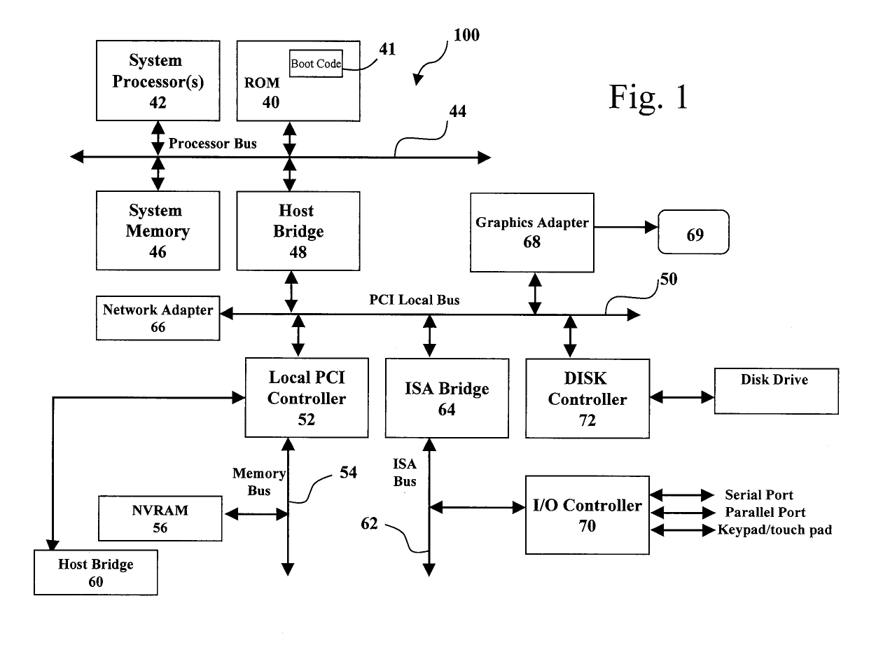

Referring now to FIG. 1, there is depicted a block diagram of an illustrative embodiment of a mobile electronic device 100. The illustrative embodiment depicted in FIG. 1 may be mobile electronic device such as a smart phone or other computing device. As is apparent from the description, however, the present invention is applicable any appropriately configured electronic device, as described herein.

As shown in FIG. 1, mobile electronic device 100 includes at least one system processor 42, which is coupled to a Read-Only Memory (ROM) 40 and a system memory 46 by a processor bus 44. System processor 42, which may comprise one of the processors produced by Intel Corporation or ARM Ltd., is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces electronic device 100 to LAN 10, and graphics adapter 68, which interfaces electronic device 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Mobile electronic device 100 further includes Industry Standard Architecture (ISA) bus 62, which is coupled to PCI local bus 50 by ISA bridge 64. Coupled to ISA bus 62 is an input/output (I/O) controller 70, which controls communication between electronic device 100 and attached peripheral devices such as a keypad, touch pad, and a disk drive. In addition, I/O controller 70 supports external communication by electronic device 100 via serial and parallel ports. The USB Bus and USB Controller (not shown) are part of the Local PCI controller (52).

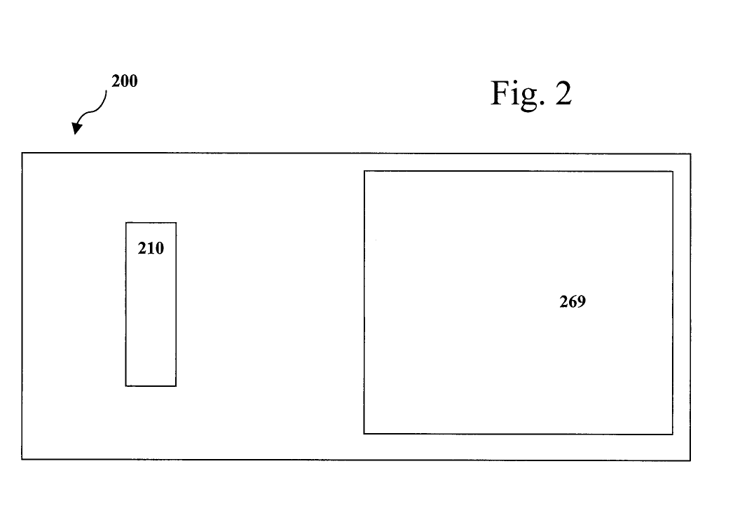

In FIG. 2 there is illustrated a simplified view of a mobile electronic device 200, such as a mobile/cellular/smart phone and the like. The mobile electronic device 200 comprises structural components, such as those described in FIG. 1, necessary to carry out the functionality as herein described. The mobile electronic device 200 comprises a display screen 269 and a user interface 210. The user interface 210 can be any of a wide variety of user interfaces, including but not limited to a keypad or keyboard, touch pad, etc. The user interface 210 can also be integrated with the display screen 269, such as with a popular “touch screen” implementation. A communications module (not shown) facilitates transmission and reception of network communications, such as page download requests and receipt of page portions, as described herein. Accordingly, the mobile electronic device 200 is capable of using an operating system and appropriate hardware components configured for communicating with remote devices via a network connection (e.g. wireless Internet connection) and downloading, displaying, manipulating and modifying pages, as described herein.

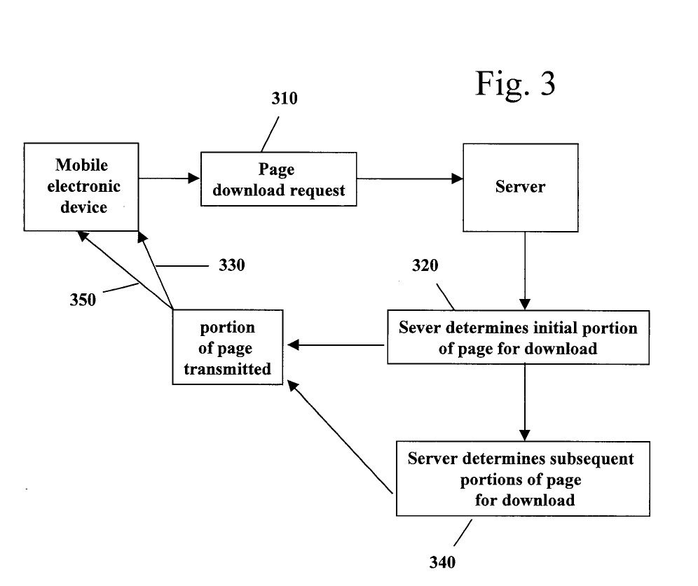

FIG. 3 illustrates a method for downloading a page such that adaptive display can be accomplished according to one embodiment of the invention. As shown, the mobile electronic device first requests the page at 310, e.g. from a remotely located server (e.g. web server) using a wireless Internet connection. A server preferably determines, in combination with information sent by the mobile electronic device page download request, an initial portion of the page for download and display at 320. The server will then transmit the initial portion of the page to the mobile electronic device at 330. While this initial portion is being viewed on the display of the mobile electronic device, the server determines at 340 and transmits at 350 subsequent portions of the page to the mobile electronic device. Thus, the remainder of the page can be downloaded in the background (e.g. via pre-fetching). Though incremental downloading of page portions is illustrated in the FIG. 3, it should be understood that a more continuous “streaming” of the page portions might be utilized to provide an animated or “movie-like” presentation, as discussed further herein.

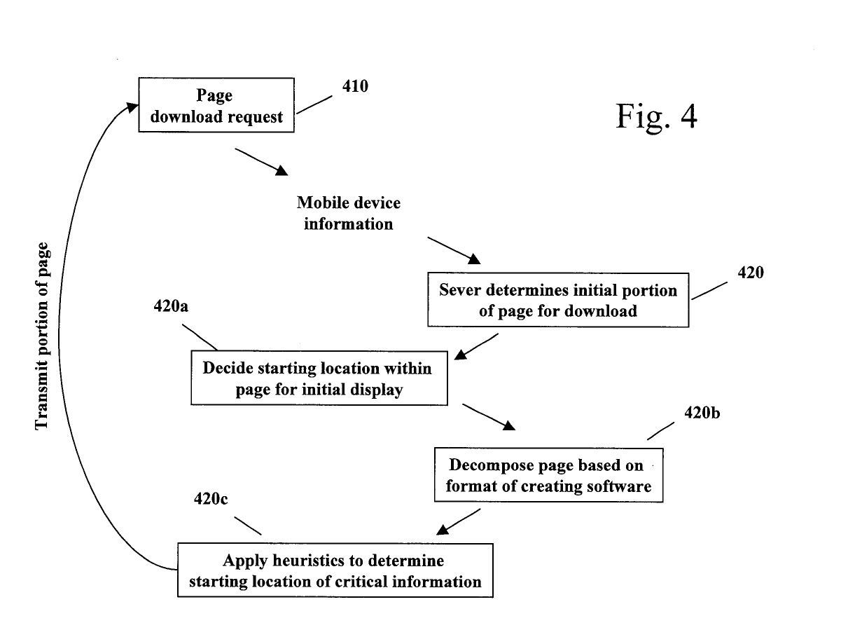

FIG. 4 illustrates a method for download and appropriate scaling of portions of the requested page. As shown, at least one presently preferred embodiment of the invention provides methods that determine which portion of a page is to be initially downloaded and scaled to fit the screen for initial display. A preferred embodiment is directed to target presentation documents created using popular software such as Microsoft® PowerPoint® and Open Document Format. A user will select a page for download at the mobile electronic device and submit the page request at 410. A component of the mobile electronic device stores and transmits mobile device information along with this page request. This mobile device information can include for example the scaling factor for initial display and the mobile device screen size, which can be transmitted along with the page download request at 410.

The server then decides an initial portion of the page for download and transmission to the client device at 420. The starting location (within the page), the scaling factor, and the screen size together determine the exact portion of the page that is to be downloaded and displayed on the device, i.e. the initial portion. The server may, for example, determine the initial portion based on the following. For each page to be downloaded for viewing on the mobile device, the server component decides the starting location within the page for initial display 420a by introspecting the page (e.g. a Microsoft® PowerPoint® slide) and decomposing it based on the format used by the creating software (e.g. Microsoft® PowerPoint®) at 420b. Based on the decomposed fragments of the page, a set of heuristics is applied to determine the starting location of critical information on the page at 420c. The starting location of critical information is then used as a reference point for determining of the initial portion of the page that is transmitted to the mobile electronic device.

For example, one heuristic is to first decide if the slide is a bullet-point slide (e.g. a Microsoft® PowerPoint® slide having bulleted information therein). If so, the beginning of the first bullet becomes the starting point (of critical information) of the portion of the page to be downloaded for initial display. A component of the mobile electronic device keeps track of how the user applies the zoom-in and zoom-out functions and based on such historical data heuristically determines the preferred font size used for display on the small screen of the mobile electronic device. The mobile electronic device sends the user preference information (e.g. historical information transmitted as part of the mobile device information) to the server as part of message in requesting the download, as illustrated at 410. The scaling factor is then derived from the user preferred font size and the actual font size of the bullet-point text on the page.

The actual portion of the page to be downloaded for initial display is decided by the starting location of critical information (e.g. first bullet point content) on the page, the scaling factor, and the screen size of the device. It should be noted that an embodiment of the invention preferably chooses a high-fidelity page, when available, as it will offer greater resolution and retain viewing quality upon zoom-in on the small screen. The high-fidelity page can be selected, even if a slow connection is encountered, as only a portion of the page (i.e. the initial portion) needs to be downloaded for the user to begin viewing the page content.

As another example, other heuristics can be used to determine that a page has a lot of a white space (or monotonic space) surrounding a more complex object or artifact in the page. This can be determined using image analysis techniques known in the art. The complex object or artifact can be selected as the initial portion of the page for download and display, scaled appropriately (e.g. enlarged). Thus, instead of downloading the entire page and then trying to display it on a small mobile electronic device, the user will see a very compact image within a very small screen, displaying the complex object or artifact. Thus, a subpart of the page (e.g. the complex object or artifact) can be selected, rather than the whole page, as the initial portion for download and display so that the initial transmission is faster and the initial display has more relevant detail for the user to perceive.

At least one embodiment of the invention provides a scan path for a page. In a large document, sometimes, the user will have to zoom and pan to see the details of a page (e.g. an image such as a map). In addition to the large amount of information needed to be downloaded to view the page (which as above can be problematic due to low-speed/low-bandwidth connections), the user must pan about the page once it finally downloads to find the desired portion. Instead of requiring the user to pan, a scan path can be proactively employed to provide an adaptive, animated viewing of the page.

A scan path is a path “through” the document implemented by determining incremental portions of the document downloaded and transmitted in an ordered fashion such that to the viewer, the document scans through the various portions. For example, the designer or creator of a page (e.g. mad document/image) can associate a multimedia artifact containing the scan path with the page. Thus, a “best viewed” like option may be applied, which implements the scan path as described herein. The scan path essentially pre-selects portions of the page and orders them for efficient incremental downloading or streaming and viewing by the user. It will be readily understood however, that users themselves may determine scan paths and/or modify predetermined scan paths, as described herein.

As a non-limiting example, in a document with a lot of bullet points, it may be “best viewed” with a certain “shape”. The “shape” starts with a particular bullet point, follows the information relating to that bullet point, and then proceeds to a next bullet point and so on throughout the scan path. Thus, the scan path is associated with the page and the server and/or the client (mobile electronic device) can use that scan path to optimally, continuously stream down (or download incrementally) the image based on what the scan path dictates. Thus, the user, when he or she sees the document on the display, does not see the image as a static image downloaded in total (that incidentally may require the user to zoom in and pan to find desired information). Instead, based on the scan path, the display of the image is dynamic and follows the scan path in a “movie like” animated showing of the whole document.

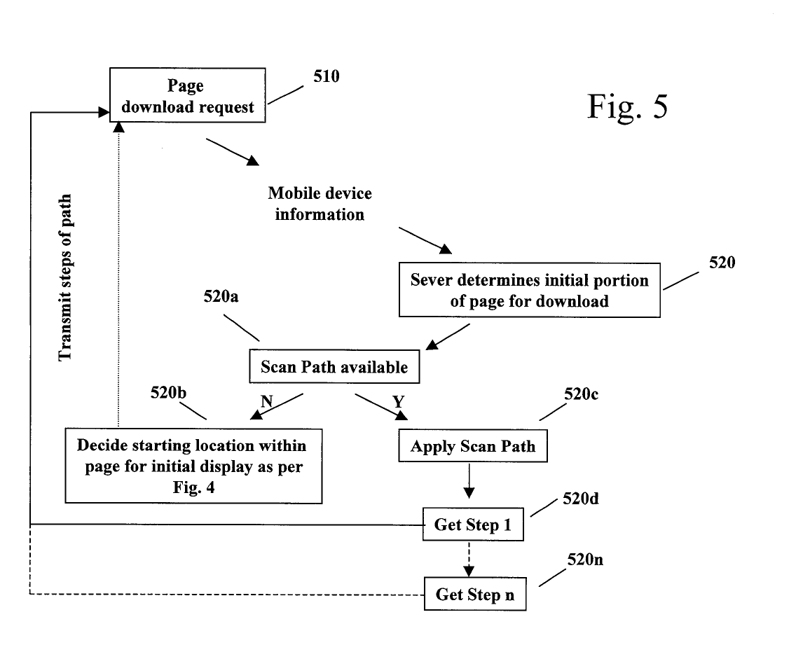

FIG. 5 illustrates a method for implementing a scan path. At 510 the user of the mobile electronic device requests a page from the server (and sends any associated mobile device information necessary, such as user preferences and/or history, screen size, etc.). At 520, the server will again determine the initial portion of the page for download and transmission. In determining the initial portion of the page, at 520a the server determines if there is a scan path associated with this particular page. If not, the process of determining the initial and remaining portions for download and transmission can be done utilizing the methods outlined above (e.g. step 520b). However, at 520a if it is determined that there is a scan path associated, the server applies the scan path at 520c.

In applying the scan path, the server determines at 520d which portion of the document has been assigned as the first “step” in the path. This first step is then downloaded and transmitted to the electronic mobile device as the initial portion. In like manner, the remaining portions of the page are transmitted in stepwise order along the scan path (520n). Thus, at the mobile electronic device, the first step in the scan path is first displayed to the user, followed seamlessly by the remaining steps. The user again can of course interface with the mobile electronic device to alter the scan path, such as pausing it, retracing prior steps, or speeding it up (i.e. viewing sequential steps more quickly than some predetermined default rate) and the like. The result of employing the scan path is preferably an animated showing of ordered portions of the document sequentially. The order may be determined in any of a wide variety of ways, including but not limited to an application specific ordering (e.g. proceed through bullet points of a slide presentation sequentially) or a user determined ordering (e.g. based on user preferences tracked and transmitted with the mobile device information).

To apply a scan path, one does not require special imaging or paging techniques because the most popular pages (e.g. images) are all designed and composed or created using formats that are well understood and modifiable for use with scan paths as herein described. Thus, the image analysis required is essentially based on knowing the format of the particular page and looking for a certain pattern, and determining the initial display of a subpart of the page that is of interest. The scan path can optionally be associated with a page in a separate format; i.e. the scan path does not have to be built into the page format itself. Thus, the scan path can be a separate artifact (e.g. text-based or a binary based).

Another usage of the scan path is for instance where two users are sharing an image between mobile devices. For instance, if User A and User B are sharing an image (stored centrally such that the users are viewing it at essentially the same time), one user can dynamically specify a scan path and drive the display of the image along at the other user's device. Thus, if User A specifies a scan path for User B, User B will see the image in animated way following that scan path. This can be implemented for example by utilizing a touch screen interface and tracking User A's viewing experience (relating to the page) and replicating it on User B's device display.

As noted above, the download of the page can be incremental, i.e. the user receives an initial portion (i.e. first step in the scan path) followed by remaining portions in some order. This gives a better/adaptive user experience because when the user is viewing the page it will take a less time for the user to get the initial portion (because it is a smaller download than the whole document). Moreover, the initial portion will be relevant in some way (i.e. as determined by the scan path and/or other heuristics) such that unnecessary scaling and panning can be avoided.

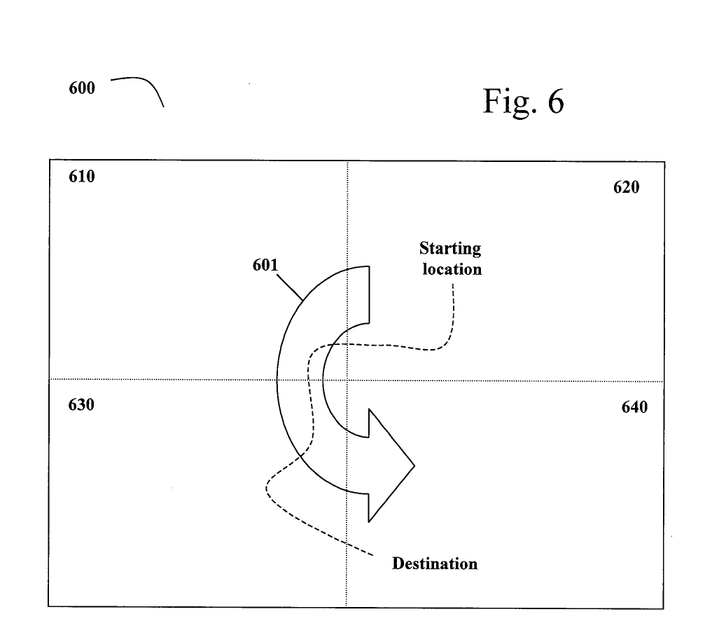

Any number of “shapes” for a scan path can be designed and implemented. As illustrated in FIG. 6, a page 600, such as a map, has a scan path 601 associated therewith (in this case roughly a “C” shape). Normally, a map will have a set of heuristics associated with certain image format, for instance, map format. Map format can dictate the image downloaded and transmitted to the user. For instance, if the user has entered a search for certain map (e.g. a starting location and a destination), the map format will dictate that the map will be centered on the point where the user's search location (route) is centered. Thus, traditionally the entire map is downloaded and the user is left to either strain to see the details of the entire map on the small screen, or zoom in and then pan about the route (indicated in FIG. 6 with the dashed line).

In contrast, an embodiment of the invention provides a scan path 601 wherein an initial portion of the map is downloaded as the first “step” of the scan path 620. Next, e.g. while the user views the first step 620, the second step 610 is downloaded. The second step 610 is next viewed by the user. Accordingly the third step 630 and fourth steps 640 will be downloaded and viewed, respectively. Thus, it is reasonable to design a scan path for animated showing of the map following such a scan path that will start from the starting location and then gradually trace the route in an animated way. Thus, many different shapes and implementations for scan paths can be designed depending upon the type of page to be viewed and/or user preferences. It should be noted here that the server, if no scan path were available, could identify the starting location on the map as the starting location of critical information within the document heuristically, as outlined in FIG. 3, achieving the same effect.

Again, any of a wide variety of “shapes” for the scan paths may be employed in different contexts. For the PowerPoint® slide scenario discussed above, a “Z” shape may be preferred for the scan path, where the upper left edge of the scan path begins with the first bullet point. The scan path could then proceed through the text associated with the first bullet point from left to right. Next, the second bullet point would be shown by traversing through the page from right to left and downward. Thereafter the text of the second bullet point could be displayed in an animated way, again from left to right.

Again, it is also possible that a consumer of the page may specify what they prefer with respect to scan paths. Thus, the user would start out receiving a default scan path but decide they do not like it and could choose a different scan path or interface with the device to indicate their own. For example, a default heuristics for the scan path could indicate for a page that the initial portion to be downloaded and displayed is the upper right corner for a particular slide or image. However, user preferences (e.g. either a particular user's and/or other users' gathered and stored by the server) could be utilized to indicate that the upper left is preferable for initial download and display. Thus, the server may determine that the upper left is the initial portion of the page, disregarding the default scan path provided by, for example, the creator of the image. Thus, community aspects may be allied to determine preferences relating to the initial portion of the page determination and/or other parts of the scan path.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus comprising:
one or more processors; and
a computer readable storage medium having computer readable program code embodied therewith, the computer readable program code, executable by the one or more processors, comprising:
computer readable program code configured to enable receiving a page download request from a mobile electronic device;
computer readable program code configured to determine an initial portion of a page related to the page download request; and
computer readable program code configured to sequentially transmit portions of the page to the mobile electronic device beginning with the initial portion of the page;
wherein the initial portion of the page is determined based on one or more of a starting location within the page, a scaling factor and a screen size of the mobile electronic device.

2. The apparatus according to claim 1, wherein the starting location comprises a location of critical information within the page.

3. The apparatus according to claim 2, wherein the location of critical information within a page is pre-determined based upon an application program type.

4. The apparatus according to claim 2, wherein the starting location is dictated by a scan path associated with the page.

5. The apparatus according to claim 4, wherein the scan path comprises instructions for enabling an animated showing of the page to a user of the mobile electronic device.

6. The apparatus according to claim 4, wherein the scan path comprises a plurality of steps.

7. The apparatus according to claim 6, wherein the plurality of steps comprise:
a first step corresponding to the initial portion of the page; and
remaining steps corresponding to ordered remaining portions of the page.

8. The apparatus according to claim 7, wherein the scan path is pre-selected and associated with page formatting instructions.

9. The apparatus according to claim 7, wherein the scan path is dictated by one or more users of one or more mobile electronic devices.

10. A method comprising:
receiving a page download request from a mobile electronic device;
determining an initial portion of a page related to the page download request; and
sequentially transmitting portions of the page to the mobile electronic device beginning with the initial portion of the page;
wherein the initial portion of the page is determined based on one or more of a starting location within the page, a scaling factor and a screen size of the mobile electronic device.

11. The method according to claim 10, wherein the starting location comprises a location of critical information within the page.

12. The method according to claim 10, wherein the location of critical information within a page is application program specific.

13. The method according to claim 10, wherein the starting location is dictated by a scan path associated with the page.

14. The method according to claim 13, wherein the scan path comprises instructions for enabling an animated showing of the page to a user of the mobile electronic device.

15. The method according to claim 13, wherein the scan path comprises a plurality of steps.

16. The method according to claim 14, wherein the plurality of steps comprise:
a first step corresponding to the initial portion of the page; and
remaining steps corresponding to ordered remaining portions of the page.

17. The method according to claim 14, wherein the scan path is pre-selected and associated with page formatting instructions.

18. The method according to claim 14, wherein the scan path is dictated by one or more users of one or more mobile electronic devices.

19. A computer readable storage medium having computer readable program code embodied therewith, the computer readable program code comprising:
computer readable program code configured to enable receiving a page download request from a mobile electronic device;
computer readable program code configured to determine an initial portion of a page related to the page download request; and
computer readable program code configured to sequentially transmit portions of the page to the mobile electronic device beginning with the initial portion of the page;
wherein the initial portion of the page is determined based on one or more of a starting location within the page, a scaling factor and a screen size of the mobile electronic device.
